(19) United States
(12) Patent Application Publication
(10) Pub. No.: US 2026/0132029 A1
(43) Pub. Date: May 14, 2026

(54) Method for Producing Manganese Iron Phosphate Particle

(71) Applicant: TOYOTA JIDOSHA KABUSHIKI KAISHA, Toyota-shi Aichi-ken (JP)

(72) Inventor: Takanori MAHARA, Toyota-shi Aichi-ken (JP)

(73) Assignee: TOYOTA JIDOSHA KABUSHIKI KAISHA, Toyota-shi Aichi-ken (JP)

(21) Appl. No.: 19/377,215

(22) Filed: Nov. 3, 2025

(30) Foreign Application Priority Data
Nov. 11, 2024 (JP) 2024-196520

(51) Int. Cl. C01B 25/45

(52) U.S. Cl. CPC C01B 25/45; C01P 2004/03

(57) ABSTRACT

A method for producing manganese iron phosphate particles, comprising: mixing metal powder containing carbon, iron and manganese with a phosphate compound in a protic solvent and stirring the mixture to obtain a slurry containing manganese iron phosphate particles; and drying the slurry to obtain the manganese iron phosphate particles.

### CROSS REFERENCE TO RELATED APPLICATIONS

This nonprovisional application is based on Japanese Patent Application No. 2024-196520 filed on Nov. 11, 2024, with the Japan Patent Office, the entire contents of which are hereby incorporated by reference.

### BACKGROUND

### Field

The present disclosure relates to a method for producing manganese iron phosphate particles.

### Description of the Background Art

Japanese Patent Laying-Open No. 2014-65641A discloses a method for producing iron phosphate by reacting iron with phosphorus to produce a precipitate and washing the precipitate. It is also disclosed that lithium iron phosphate is produced by reacting the obtained iron phosphate with a lithium compound.

Japanese Patent Laying-Open No. 2016-81866A discloses a method for producing lithium manganese iron phosphate by hydrothermal reaction.

### SUMMARY

Lithium iron phosphate or lithium manganese iron phosphate is used as the positive electrode active material. 1. As disclosed in JP2014-65641A, iron phosphate is present as a suitable precursor for lithium iron phosphate. On the other hand, with respect to lithium manganese iron phosphate, there is no suitable precursor, and a method capable of producing lithium manganese iron phosphate at low cost has not been established.

As disclosed in JP2016-81866A, lithium manganese iron phosphate can be produced by hydrothermal reaction. On the other hand, since the lithium manganese iron phosphate obtained by the production method has a large particle size and needs to be further pulverized in order to be used as a positive electrode active material, it takes a long time to perform pulverization.

An object of the present disclosure is to provide a method for producing manganese iron phosphate particles capable of reducing the pulverization time.

[1] A method for producing manganese iron phosphate particles, comprising:
mixing metal powder containing carbon, iron and manganese with a phosphate compound in a protic solvent and stirring the mixture to obtain a slurry containing manganese iron phosphate particles,
drying the slurry to obtain the manganese iron phosphate particles.

When metal powder containing carbon, iron, and manganese and a phosphate compound are mixed in a protic solvent and stirred, a hydrocarbon gas such as hydrogen, methane, or ethane is generated. Since the manganese iron phosphate particles synthesized by such a method involving generation of gas spontaneously become fine particles by gasification, pulverization is not required. As a result, it is expected to shorten the grinding time. Further, as a suitable precursor of lithium manganese iron phosphate, it is expected to contribute to cost reduction.

[2] The method for producing manganese iron phosphate particles according to [1], wherein a molar ratio of iron to manganese in the metal powder is (20 to 30):(70 to 80).

[3] The method for producing manganese iron phosphate particles according to [1] or [2], wherein the metal powder is ferromanganese.

[4] The method for producing manganese iron phosphate particles according to any one of [1] to [3], wherein a content of carbon in the metal powder is from 4 mass % to 7 mass %.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a schematic flowchart of a method for producing lithium manganese iron phosphate in the present embodiment.

FIG. 2 is an example of an SEM image of manganese iron phosphate particles of No. 1.

FIG. 3 is an example of an SEM image of manganese iron phosphate particles of No. 2.

FIG. 4 is an example of an SEM image of manganese iron phosphate particles of No. 3.

FIG. 5 is an example of an SEM image of a manganese phosphate particle of No. 4.

FIG. 6 is an example of an SEM image of No. 5 iron phosphate particles.

FIG. 7 is an example of an SEM image of manganese iron phosphate particles of No. 6.

### DESCRIPTION OF THE EMBODIMENTS

Hereinafter, one embodiment of the present disclosure (Hereinafter, it may be abbreviated as “the present embodiment”.) and one example of the present disclosure (Hereinafter, it can be abbreviated as “the present example”.) will be described. However, the present embodiment and the present example do not limit the technical scope of the present disclosure.

The manganese iron phosphate particles produced in the present embodiment can be used in the production of lithium manganese iron phosphate. In addition, lithium manganese iron phosphate is suitably used, for example, as an electrode active material for secondary batteries, particularly as a positive electrode active material for non-aqueous electrolyte secondary batteries.

### <Method for Producing Manganese Iron Phosphate Particle>

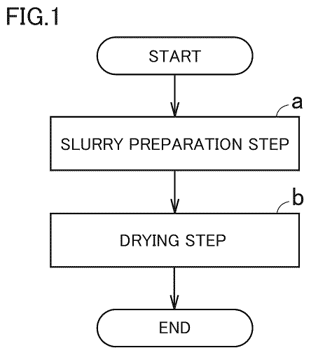

FIG. 1 is a schematic flowchart of a method for producing manganese iron phosphate particles in the present embodiment. Hereinafter, “a method for producing manganese iron phosphate particles in the present embodiment” may be abbreviated as “the present production method”. The present production method includes at least (a) a slurry preparation step and (b) a drying step.

### ((a) Slurry Preparation Step)

In the slurry preparation step, a metal powder containing carbon, iron and manganese and a phosphate compound are mixed in a protic solvent and stirred to obtain a slurry containing manganese iron phosphate particles.

Examples of the metal powder containing carbon, iron, and manganese include a powder obtained by mixing a carbon powder, an iron powder and a manganese powder, and an iron-manganese alloy powder containing carbon. In embodiments, in the metal powder containing carbon, iron, and manganese, the molar ratio of iron to manganese is (0 to 50):(50 to 100) or (20 to 30):(70 to 80). The manganese iron phosphate particles obtained by using such a metal powder are expected to contribute to improvement of the characteristics of the secondary battery.

In embodiments, as the iron-manganese alloy powder containing carbon, ferromanganese is used. Ferromanganese is an iron-manganese alloy containing a high capacity of manganese, and is classified into high-carbon ferromanganese, medium-carbon ferromanganese, low-carbon ferromanganese and the like depending on the content of carbon (see JIS standard G2301). Ferromanganese is mass-produced worldwide, is available at low cost, and has aspects of being close to the composition of iron and manganese (iron:manganese=(20 to 30):(70 to 80) (molar ratio)) of lithium manganese iron phosphate currently used as a positive electrode active material.

The content of carbon in the metal powder containing carbon, iron, and manganese may be from 0.5 mass % to 10 mass %. When the content of carbon in the metal powder containing carbon, iron and manganese is within the above range, microparticulation of the obtained manganese iron phosphate particles is promoted. The content of carbon in the metal powder containing carbon, iron, and manganese may be from 1% by mass to 8% by mass, and may be from 4% by mass to 7% by mass.

Examples of the phosphate compound include phosphoric acid, ammonium dihydrogen phosphate, and diammonium hydrogen phosphate. In embodiments, among these, phosphoric acid is desirable from the viewpoint of enhancing battery characteristics, and a phosphoric acid aqueous solution of 70 to 90% by mass is used.

Examples of the protic solvent include water and alcohols such as methanol and ethanol. In embodiments, among these, water is desirable from the viewpoint of cost.

In this step, a metal powder containing carbon, iron and manganese and a phosphate compound are mixed in a protic solvent and stirred. When a metal powder containing carbon, iron, and manganese and a phosphate compound are mixed in a protic solvent and stirred, a hydrocarbon gas such as hydrogen, methane, or ethane is generated. Since the manganese iron phosphate particles synthesized by such a method involving generation of gas spontaneously become fine particles by gasification, pulverization is not required. As a result, it is expected to shorten the grinding time.

The stirring may be performed, for example, by adding a metal powder containing carbon, iron, and manganese to a protic solvent to prepare a slurry, and then dropping a phosphate compound. The stirring speed when the phosphate compound is dropped may be, for example, 100 to 1000 rpm. In embodiments, the stirring time is not particularly limited, but stirring is continued until the generation of gas is finished.

Through this step, manganese iron phosphate particles are formed in the slurry. After stirring, the slurry may be filtered.

After stirring, the resulting slurry may be ground. The obtained slurry is pulverized to obtain manganese iron phosphate particles having a desired particle size. The pulverization may be performed by, for example, a ball mill, a bead mill, a planetary mill, a jet mill, a planetary mixer, a homogenizer, or the like. The grinding time is not particularly limited, and may be, for example, 5 to 60 minutes. After grinding, the slurry may be filtered.

### ((b) Drying Step)

In the drying step, a slurry containing manganese iron phosphate particles is dried to obtain manganese iron phosphate particles.

Drying is performed in any manner. For example, the slurry may be dried by a spray dryer or hot air.

The primary particle diameter of the manganese iron phosphate particles obtained by the present production method may be, for example, 800 nm or less, 600 nm or less, or 400 nm or less. The particle diameter of the manganese iron phosphate particles obtained by the present production method may be, for example, 50 nm or more, 100 nm or more, or 200 nm or more.

The shape of the manganese iron phosphate particles obtained by the present production method may be, for example, spherical, columnar, bulky, or scale-like. In embodiments, the shape of the manganese iron phosphate particles obtained by the present production method is spherical. The spherical manganese iron phosphate particles are expected to contribute to improvement of the characteristics of the secondary battery.

### EMBODIMENTS

### <No. 1>

High carbon ferromanganese was charged into the water. Thereafter, 75 mass % of phosphoric acid was added dropwise and stirred to obtain a slurry. Stirring was performed for 1 hour until gas evolution ceased. The obtained slurry was dried by hot air at 80° C. to obtain manganese iron phosphate particles of No. 1. The high-carbon ferromanganese contained 6.8 mass % of carbon, and the molar ratio of iron to manganese in the high-carbon ferromanganese was 8:2. The high-carbon ferromanganese and phosphoric acid were mixed so that the molar ratio of iron and manganese in the high-carbon ferromanganese to phosphorus in the phosphoric acid was 1:1.

### <No. 2>

Medium carbon ferromanganese was charged into the water. Thereafter, 75 mass % of phosphoric acid was added dropwise and stirred to obtain a slurry. Stirring was performed for 1 hour until gas evolution ceased. The obtained slurry was dried by hot air at 80° C. to obtain manganese iron phosphate particles of No. 2. The medium carbon ferromanganese contained 1.8 mass % of carbon, and the molar ratio of iron to manganese in the medium carbon ferromanganese was 8:2. The medium carbon ferromanganese and phosphoric acid were mixed so that the molar ratio of iron and manganese in the medium carbon ferromanganese to phosphorus in the phosphoric acid was 1:1.

### <No. 3>

Low carbon ferromanganese was charged into the water. Thereafter, 75 mass % of phosphoric acid was added dropwise and stirred to obtain a slurry. Stirring was performed for 1 hour until gas evolution ceased. The obtained slurry was dried by hot air at 80° C. to obtain manganese iron phosphate particles of No. 3. The low-carbon ferromanganese contained 0.8% by mass of carbon, and the molar ratio of iron to manganese in the low-carbon ferromanganese was 8:2. Low-carbon ferromanganese and phosphoric acid were mixed so that the molar ratio of iron and manganese in the low-carbon ferromanganese to phosphorus in the phosphoric acid was 1:1.

### <No. 4>

Manganese powder was added to water. Thereafter, 75 mass % of phosphoric acid was added dropwise and stirred to obtain a slurry. Stirring was performed for 1 hour. The obtained slurry was put into a ball mill and pulverized for 30 minutes using a 5 mm ball. The pulverized slurry was dried by hot air at 80° C. to obtain manganese phosphate particles of No. 4. Manganese powder and phosphoric acid were mixed so that the molar ratio of manganese to phosphorus in phosphoric acid was 1:1. The manganese powder did not contain carbon.

### <No. 5>

Iron powder was added to the water. Thereafter, 75 mass % of phosphoric acid was added dropwise and stirred to obtain a slurry. Stirring was performed for 1 hour. The obtained slurry was put into a ball mill and pulverized for 30 minutes using a 5 mm ball. The pulverized slurry was dried by hot air at 80° C. to obtain No. 5 iron phosphate particles. The iron powder and the phosphoric acid were mixed so that the molar ratio of iron to phosphorus in the phosphoric acid was 1:1. The iron powder did not contain carbon.

### <No. 6>

Manganese powder and iron powder were added to water. Thereafter, 75 mass % of phosphoric acid was added dropwise and stirred to obtain a slurry. Stirring was performed for 1 hour. The obtained slurry was put into a ball mill and pulverized for 30 minutes using a 5 mm ball. The pulverized slurry was dried by hot air at 80° C. to obtain No. 6 manganese iron phosphate particles. The manganese powder, the iron powder, and the phosphoric acid were mixed so that the molar ratio of manganese and iron to phosphorus in the phosphoric acid was 1:1. The manganese powder and the iron powder did not contain carbon.

### <Observation>

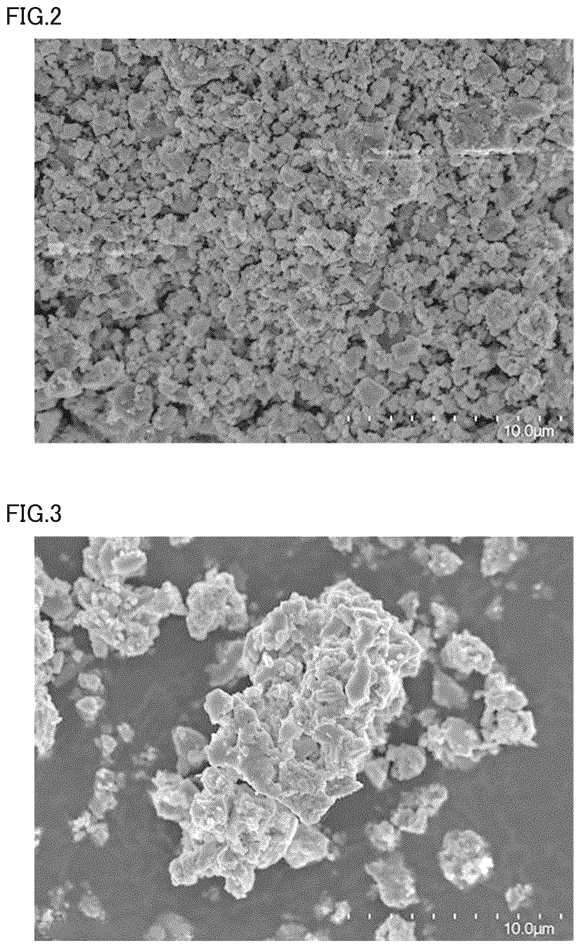

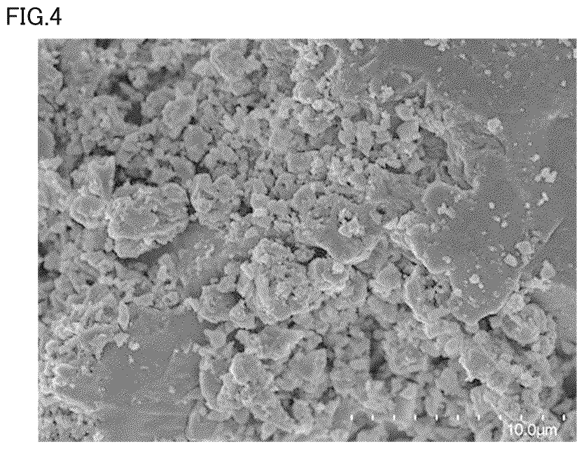

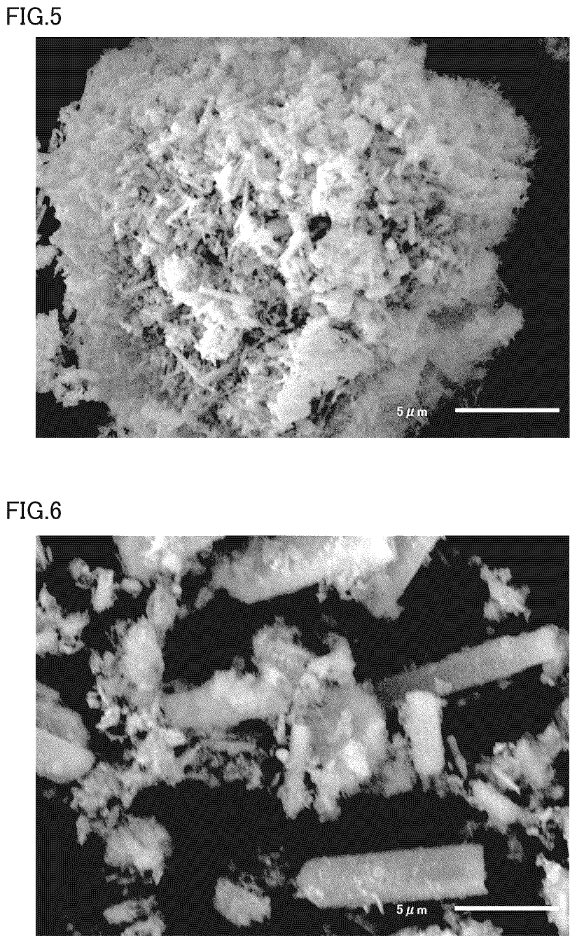

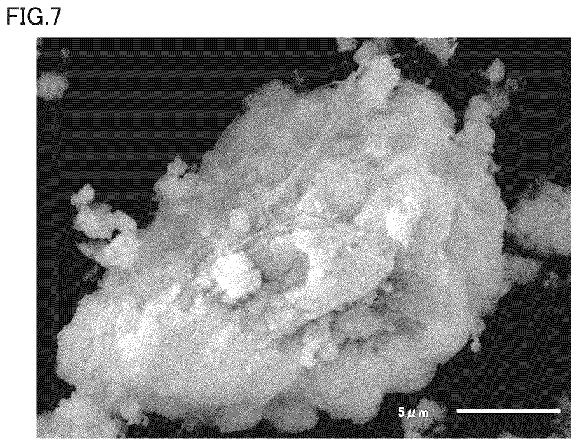

Each particle of Nos. 1 to 6 was observed by SEM (Scanning Electron Microscope) (magnification: 5000 times). SEM images of each No. are shown in FIGS. 2 to 7.

Further, the particle diameters of the primary particles of Nos. 1 to 6 were calculated and the shapes thereof were confirmed. The primary particle diameter was calculated as an average value of distances between two farthest points on the contour line of 10 or more primary particles randomly extracted from each SEM image. The average particle diameter and shape of the primary particles of Nos. 1 to 6 are shown in Table 1.

TABLE 1

| | Average | |
|---|---|---|
| | particle size | |
| No. | (nm) | Shape |
| 1 | 200 | Spherical |
| 2 | 400 | Spherical |
| 3 | 600 | Spherical |
| 4 | 200 | Columnar |
| 5 | 600 | Columnar |
| 6 | 1000 | Bulky |

From FIGS. 2 to 4 and Table 1, it was confirmed that the manganese iron phosphate particles of Nos. 1 to 3 were micronized without grinding. On the other hand, each particle of Nos. 4 to 6 was finely divided through a separate pulverization step.

The shape of the manganese iron phosphate particles of Nos. 1 to 3 was spherical. When lithium manganese iron phosphate is used as a positive electrode active material for a secondary battery, it is considered that the lithium manganese iron phosphate has a spherical shape and thus contributes to improvement in characteristics of the secondary battery. In general, it is considered that a positive electrode active material having a small particle diameter contributes to improvement in characteristics of a secondary battery as compared with a positive electrode active material having a large particle diameter. Thus, it is considered that the manganese iron phosphate particles of Nos. 1 to 3 are suitable for use as a precursor of lithium manganese iron phosphate. Further, as a precursor of lithium manganese iron phosphate, production at low cost is also expected.

The present embodiment and the present example are illustrative in any respect. The present embodiment and the present example are non-restrictive. The technical scope of the present disclosure encompasses any modifications within the meaning and the scope equivalent to the terms of the claims. For example, it is originally planned that certain configurations of the present embodiment and the present example can be optionally combined.

Although the embodiments of the present disclosure have been described, the embodiments disclosed herein are illustrative and non-restrictive in any respect. The scope of the present disclosure is defined by the terms of the claims, and is intended to encompass any modifications within the meaning and the scope equivalent to the terms of the claims.

What is claimed is:

1. A method for producing manganese iron phosphate particles, comprising:
mixing metal powder containing carbon, iron and manganese with a phosphate compound in a protic solvent and stirring the mixture to obtain a slurry containing manganese iron phosphate particles; and
drying the slurry to obtain the manganese iron phosphate particles.

2. The method for producing manganese iron phosphate particles according to claim 1, wherein a molar ratio of iron to manganese in the metal powder is (20 to 30):(70 to 80).

3. The method for producing manganese iron phosphate particles according to claim 1, wherein the metal powder is ferromanganese.

4. The method for producing manganese iron phosphate particles according to claim 1, wherein a content of carbon in the metal powder is from 4 mass % to 7 mass %.
